(19) United States
(12) Patent Application Publication
(10) Pub. No.: US 2010/0161177 A1
(43) Pub. Date: Jun. 24, 2010

(54) Vehicle glare reducing systems

(76) Inventor: Seymour C. Yuter, Briarcliff Manor, NY (US)

Correspondence Address: Dr. Seymour C. Yuter, 407 Cedar Drive West, Briarcliff Manor, NY, 10510, US

(21) Appl. No.: 12/660,486

(22) Filed: Feb. 27, 2010

Related U.S. Application Data
(63) Continuation-in-part of application No. 12/655,446, filed on Dec. 30, 2009.
Application No. 12/655,446 is a continuation-in-part of application No. 11/890,409, filed on Aug. 6, 2007, now Pat. No. 7,669,636.

(51) Int. Cl. B60J 3/04; G06F 7/00

(52) U.S. Cl. 701/36; 296/97.2

(57) ABSTRACT

A method of reducing glare from oncoming vehicle headlights in a vehicle having a driver's side, a passenger side, a front windshield and a steering wheel comprises the steps of: providing a glare reducing means such as SMART GLASS on the vehicle adapted to substantially transmit light and to substantially reduce light, the glare reducing means having a width less than 30 percent of the horizontal width of the vehicle's front windshield such that the passenger side is uncovered; driving the vehicle on a surface that can have oncoming traffic; operating the glare reducing means while driving to substantially transmit light to allow a driver to see through the glare reducing means when there is no oncoming traffic with lit headlights approaching; operating the glare reducing means to substantially reduce light while driving to reduce glare when there is at least one oncoming vehicle with lit headlights approaching the driver; and repeating the substantially light transmitting and substantially light reducing steps by the glare reducing means while driving to accommodate varying oncoming traffic. The glare reducing means can be operated manually by a wireless ON/OFF switch attached to the steering wheel or automatically by a high-beam headlight control system on the vehicle. And it can be installed as an attachment in an existing vehicle or as original equipment in new vehicle.

This application is a continuation-in-part of prior application Ser. No. 12/655,446 filed Dec. 30, 2007, for Vehicle Glare Blocking Systems, which is a continuation in part of prior application Ser. No. 11/890,409 filed Aug. 6, 2007, for Glare Blocking Vehicle Attachment (“parent application”), issued Mar. 2, 2010 as U.S. Pat. No. 7,669,636.

### BACKGROUND OF THE INVENTION

1. Field of the Invention

This invention pertains to safety systems for vehicles and more particularly to vehicle glare reducing systems to reduce beam glare of headlights of oncoming vehicles to prevent dangerous and even blinding glare, especially in the eyes of older drivers, mainly on two lane roads and particularly when it is raining.

2. Background of the Invention

Driving requires effective coordination of visual, motor and cognitive skills. Visual skills are pushed to their limit at night by decreased illumination and by disabling glare from oncoming headlights. Glare is proportional to headlight brightness so increasing headlight brightness also increases glare for drivers, especially on two lane roads and particularly in the rain. This problem is worse for older drivers because of their increased intraocular light scattering, glare sensitivity and photostress recover time.

Modern vehicle headlights are electrically operated, positioned in pairs, one or two on each side of the front of a vehicle. A headlight system produces a low and a high beam. High beams are used when other vehicles are not present on the oncoming side of the road. Low beams have stricter control of upward light, and direct most of their light downward and either rightward (in right-traffic countries) or leftward (in left-traffic countries) to provide safe forward visibility without excessive glare.

A night driving problem, especially for older drivers on two lane roads, and particularly when it is raining, is that oncoming high beams can be blinding, and even oncoming low beams can cause dangerous glare. That is because, with increasing age, cataracts in the eye's lens scatter the oncoming light.

A cataract is the clouding of the normally transparent lens within the eye. The lens is located directly behind the pupil and normally assists in focusing light for clear vision. As the cataract worsens it prevents light from coming through the pupil and focusing clearly on the retina. Early changes may be very minor, but as the process continues symptoms of blurred vision, light sensitivity, glare and night driving difficulties increase. The nighttime driving difficulties are mainly caused by headlight glare. It takes a typical driver ten seconds to recover from headlight glare and this time increases with age. At 30 miles an hour a car travels an eighth of a mile in 10 seconds.

This nighttime driving problem has intensified with vision-disabling nighttime glare from three types of headlights mounted on the front of motor vehicles: “high intensity discharge” (HID) lights that appear blue, auxiliary lights such as “fog lamps”, and headlights mounted high on various light trucks (sport utility vehicles, pickups and vans).

According to a U.S. Department of Transportation Technical Report (DOT HS 809 669 October 2003), 31% of drivers are disturbed by headlight glare and 1% had a crash or near miss. And, surprisingly, many more 35-54 drivers are disturbed by headlight glare than older drivers. Finally, nighttime driving difficulties from headlights and glare are exacerbated in the rain and especially heavy rain to the point that a driver can be blinded.

### BRIEF SUMMARY OF THE INVENTION

A general object of the invention is to improve the safety of nighttime drivers.

Another object of the invention is to improve the safety of older drivers, especially when driving on two lane roads and particularly in the rain.

A further object of the invention is to provide an improved attachment for a vehicle and an improved method of using the attachment which reduces the glare from headlight beams from oncoming vehicles to prevent dangerous glare in the eyes of nighttime drivers.

A still further object of the invention to provide an improved apparatus and an improved method for original equipment in vehicles which reduces glare from headlight beams from oncoming vehicles to prevent dangerous glare in the eyes of nighttime drivers.

A specific object of the invention is to provide a vehicle glare reducing system which automatically reduces glare from headlight beams from oncoming vehicles to prevent dangerous glare in the eyes of nighttime drivers.

This invention employs light valves or SMART GLASS panels. In liquid crystal SMART GLASS, liquid crystals are dissolved or dispersed into a liquid polymer followed by solidification or curing of the polymer. During the change of the polymer from a liquid to solid, the liquid crystals become incompatible with the solid polymer and form droplets throughout the solid polymer. The curing conditions affect the size of the droplets that in turn affect the final operating properties of the “smart window”. Typically, the liquid mix of polymer and liquid crystals is placed between two layers of glass or plastic that include a thin layer of a transparent, conductive material followed by curing of the polymer, thereby forming the basic sandwich structure of the smart window. This structure is in effect a capacitor. Electrodes from a power supply are attached to the transparent electrodes. With no applied voltage, the liquid crystals are randomly arranged in the droplets, resulting in scattering of light as it passes through the smart window assembly. This results in the translucent, “milky white” appearance. When a voltage is applied to the electrodes, the electric field formed between the two transparent electrodes on the glass causes the liquid crystals to align, allowing light to pass through the droplets with very little scattering and resulting in a transparent state. The degree of transparency can be controlled by the applied voltage.

Briefly, in accordance with the preferred method of the invention, a method of reducing glare from oncoming vehicle headlights in a vehicle having a driver's side, a passenger side, a front windshield and a steering wheel comprises the steps of: providing a glare reducing means such as SMART GLASS on the vehicle adapted to substantially transmit light and to substantially reduce light, the glare reducing means having a width less than 30 percent of the horizontal width of the vehicle's front windshield such that the passenger side is uncovered; driving the vehicle on a surface that can have oncoming traffic; operating the glare reducing means while driving to substantially transmit light to allow a driver to see through the glare reducing means when there is no oncoming traffic with lit headlights approaching; operating the glare reducing means to substantially reduce light while driving to reduce glare when there is at least one oncoming vehicle with lit headlights approaching the driver; and repeating the substantially light transmitting and substantially light reducing steps by the glare reducing means while driving to accommodate varying oncoming traffic.

A feature of the invention is a wireless switch attached to the vehicle's steering wheel to operate the glare reducing means to substantially transmit visible light so the driver can see through the glare reducing means when there is no oncoming vehicle with glaring headlights or to substantially reduce transmitted light when there is an oncoming vehicle with glaring headlights to reduce the glare.

Another feature of the invention is to provide automatic optical detecting means on the vehicle for automatically optically detecting when at least one oncoming vehicle with lit headlights is approaching the driver to automatically operate the glare reducing means to substantially reduce transmitted light to reduce headlight glare and automatically operating the glare reducing means to substantially transmit light when an oncoming vehicle with lit headlights is not approaching to allow a driver to see through the glare reducing means.

SMART GLASS has been used in automobile side windows and front windshields to switch the entire window from substantially clear to substantially opaque for privacy.

The SMART GLASS of the invention, totally opposite to this teaching, is used with only a small portion of the front windshield on the driver's side to substantially reduce oncoming vehicle headlight glare and not for privacy. And when activated to reduce oncoming headlight glare, only reduces the driver's vision through a portion of the driver's side of the vehicle's front windshield and thus the view of most of the oncoming traffic lane, but the driver can always see all of the vehicle's lane, and is used only at nighttime to reduce glaring and blinding headlight beams of oncoming vehicles in the oncoming lane, especially on two lane roads and in the rain.

An advantage of the invention is that suitable SMART GLASS is commercially available from many suppliers at a reasonable cost, as is the electric circuitry to almost instantly change the SMART GLASS from substantially transparent to substantially opaque and then back to substantially transparent.

Another advantage of the invention is that the automatic optical detection apparatus is commercially available to dim a driver's headlight high beams to low beams when an oncoming vehicle with on headlights is detected and return to high beams after the oncoming vehicle passes. Contrary to that teaching, the automatic optical detection apparatus in this invention is modified to switch the SMART GLASS to reduce glare from oncoming vehicles or, when no vehicle is oncoming, to switch the SMART GLASS to enable the driver to see through it.

A further advantage of the invention is that the headlight glare reducing system can be installed in existing vehicles as attachments, or built into new vehicles as original equipment.

### DESCRIPTION OF RELATED ART

The descriptions of related art in the prior parent and continuation-in-part applications are hereby incorporated by reference.

As indicated above, the invention in this specification employs SMART GLASS, a light valve. Light valves have been proposed for use in numerous applications including windows in buildings, automobile side windows and sunroofs, alphanumeric and graphic displays, television displays, filters for lamps, cameras, optical fibers, sunvisors, eyeglasses, goggles and mirrors to control the amount of light passing therethrough or reflected therefrom. Light valves have never been used, until this invention, to block headlight glare from oncoming vehicles.

The invention first reduced to practice used a liquid crystal SMART GLASS designed for attaining privacy in building windows, either inside to enclose a conference room, or outside to control the amount of light and therefore heat entering a building. Privacy glass, as illustrated in FIG. 3, has a liquid crystal film 30 laminated between two sheets of glass 32, 34. In a non-energized state, the liquid crystal molecules disperse light, but when energized the liquid crystal molecules are aligned in a manner which permits parallel light to pass through the film. In its unenergized or natural state the liquid crystal film is substantially opaque. It has a milky white appearance and substantially prevents objects from being seen through it. In its substantially transparent state it transmits over 75 percent of the parallel light in the visible spectrum and, in once case, 86 percent.

An embodiment of the invention in this specification also employs a high-beam headlight control system. A high-beam headlight control system is disclosed in detail in U.S. Pat. No. 5,537,003 (003 patent) for a Control System for Automotive Vehicle Headlamps and Other Vehicle Equipment issued Jul. 16, 1996, to Gentex Corporation of Zeeland, Mich. This system operates automatically to switch the headlights from high beam to low beam when an oncoming vehicle with headlight glare is detected. And it operates to switch the headlights from low beam to high beam when an oncoming vehicle with headlight glare is not detected. There is no remote suggestion in the 003 patent for using a light valve or SMART GLASS to substantially reduce visible transmitted light or to substantially transmit visible light, and thus substantially block oncoming headlight glare from an oncoming vehicle or allow the driver to see through the light valve or SMART GLASS when there is no oncoming vehicle with lit headlights.

Most importantly, there is no suggestion of this invention in the 110-page publication prepared for The AAA Foundation for Traffic Safety, Washington, D.C., in December 2001, entitled “Countermeasures for Reducing the Effects of Headlight Glare.” This AAA publication also reports that as many as 50 percent of all headlights on the road may be misaimed, further aggravating the problem of headlight glare.

### BRIEF DESCRIPTION OF THE DRAWINGS

Other objects, features and advantages of the invention will be apparent from the following description taken together with the accompanying drawings in which:

FIG. 1 is a front elevational view taken from the vehicle's driver's seat showing a glare reducing attachment comprising a SMART GLASS panel whose corners are VELCRO-attached to the vehicle's front windshield, a steering wheel and a wireless ON/OFF switch which is VELCRO-attached to the steering wheel with an ON button to apply 120 volts AC to the SMART GLASS panel to make the entire panel substantially clear and an OFF button to terminate the 120 volts to make the entire panel substantially opaque. When substantially opaque the SMART GLASS panel substantially reduces headlight glare from an oncoming vehicle on the left side of the road and when substantially clear the driver can see the left side of the road while always seeing the right or driver's side of the road. While the SMART GLASS is shown partially opaque and partially transparent the SMART GLASS is in either one of those states but never both.

FIG. 2 is a side perspective view of the glare blocking vehicle attachment of FIG. 1 showing the SMART GLASS panel mounted on the vehicle's slanted front windshield together with the steering wheel.

FIG. 3 is a cross-sectional view of the SMART GLASS panel of FIGS. 1 and 2 showing its laminated layers between two glass panes and how it works to go from substantially transparent to substantially opaque.

FIG. 4 is a block diagram of the electric circuitry under wireless control of the wireless ON/OFF switch of FIG. 1 comprising a wireless ON-OFF relay feeding 12 VDC to an inverter whose 120 VAC output turns the SMART GLASS panel ON to make the panel substantially clear and when the 120 VAC IS OFF to make the SMART GLASS panel substantially opaque.

FIG. 5 is a simplified pictorial diagram viewed through a vehicle windshield which depicts the major components of the automatic high-beam headlight control system attached to the front windshield and with a wireless transmitter for automatically turning the SMART GLASS from substantially transparent to substantially opaque.

FIG. 6 is a simplified side elevational view of the automatic-high beam headlight control system of FIG. 5 installed as original equipment in a new vehicle.

FIG. 7 is a cross-sectional view of the SMART GLASS portion of a new vehicle's laminated front windshield installed as original equipment.

### DESCRIPTION OF PREFERRED EMBODIMENT OF THE INVENTION

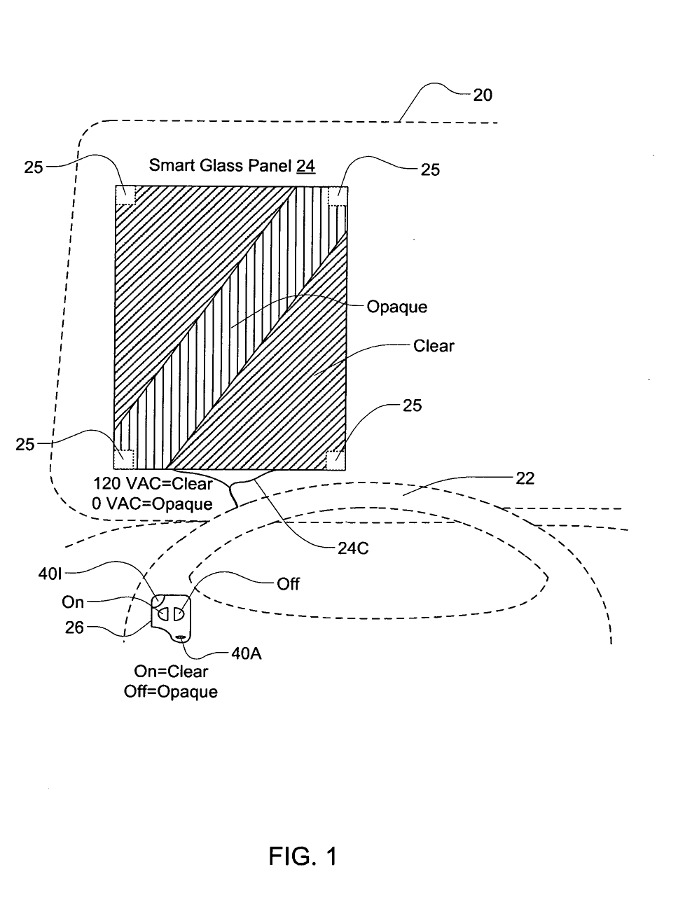

Referring to the glare reducing attachment in FIG. 1, as viewed from the driver's seat of a vehicle, the driver's side of the front windshield 20 is shown together with the vehicle's steering wheel 22. Attached to front windshield 20 is SMART GLASS panel 24 which is switched from substantially opaque to substantially transparent upon the application of a 120 alternate current voltage via connector wires 24C. SMART GLASS panel 24 is very strongly attached to front windshield 20 by four industrial-strength VELCRO pads 25, one in each corner of SMART GLASS panel 24, each about one inch square and preferably transparent, though white as the invention was reduced to practice.

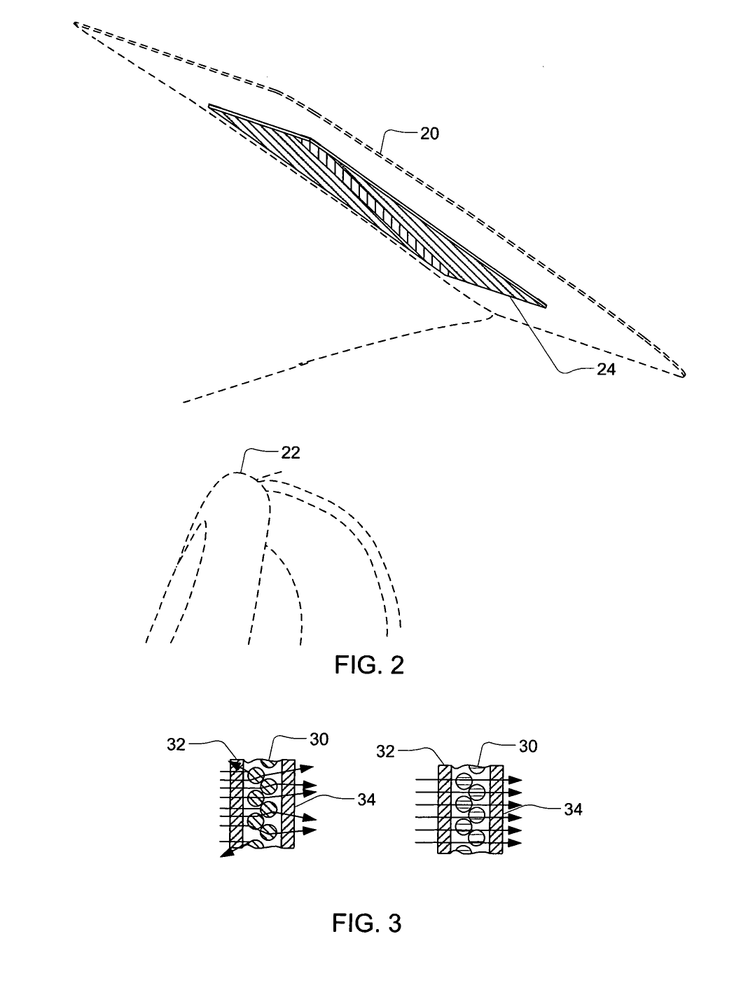

FIG. 2 is a side perspective view of the slanted front windshield 20, the steering wheel 22 and the SMART GLASS panel 24.

In FIG. 1, VELCRO-attached to steering wheel 22 is wireless ON/OFF switch 26. The VELCRO (not shown but between switch 26 and steering wheel 22) is similarly industrial strength and about one inch square. Switch 26 is attached to the steering wheel 22 adjacent the driver's left hand when holding the steering wheel 26. Thus the driver's thumb can handily depress either the ON button or the OFF button. When the ON button is depressed SMART GLASS panel 24 becomes substantially transparent, which is the normal driving condition and for vehicle left turns.

During nighttime driving the driver can rest his or her thumb on the OFF button, ready to depress it in the event of an oncoming vehicle with lit headlights to substantially reduce the headlight glare and block blinding glare. After depressing the OFF button, the driver's thumb is preferably moved over to the ON button to be able to press it and return SMART GLASS panel 24 to the substantially clear state after the vehicle's headlights no longer shine on the driver. When the SMART GLASS panel 24 is substantially opaque oncoming headlights can be seen though the panel but so substantially reduced in brightness as not to cause glare and especially not cause blinding glare. So the driver knows when the oncoming headlight glare is no longer a problem because the oncoming vehicle has mostly passed the driver's vehicle.

Pressing the ON button of ON/OFF wireless switch 26 causes SMART GLASS panel 24 to be substantially transparent, which is the normal driving status of SMART GLASS panel 24 during the daylight and when there is no oncoming vehicle with lit headlights during nighttime driving and for left hand turns. With SMART GLASS panel 24 substantially transparent the driver can easily see the entire view through the front windshield 20, and especially both lanes of a two-lane road. A two-lane road provides the worst danger of blinding headlight glare from an oncoming vehicle during nighttime driving.

SMART GLASS 24 preferably is eight by eleven inches in size, with its right edge substantially vertically aligned with the horizontal center of steering wheel 22. With that alignment the driver can always see the driver's lane of a two lane road.

In nighttime driving, with the onset of an incoming vehicle with bright and possibly blinding headlight glare, the driver can push button OFF of wireless ON/OFF switch 26 to instantly convert SMART GLASS panel 24 from substantially transparent to substantially opaque. When substantially opaque SMART GLASS panel 24 substantially reduces the glare from the oncoming vehicle to an easily tolerable pair of lights. The driver, by moving his or her head to the left, can increase the amount of blocking of the headlights of oncoming vehicles to avoid blinding glare. That is mainly a problem when the road is straight. If the road curves in either direction, headlight glare is only momentary and can be tolerated or SMART GLASS panel 24 can momentarily be made substantially opaque by pushing the OFF button of switch 26.

Also, when the driver must make a left turn, almost all times without the problem of oncoming vehicle headlight glare, SMART GLASS panel 24 must be in the transparent position in order to see both lanes of a two-lane road.

The headlight glare problem is much less severe with roads of three or more lanes.

SMART GLASS panel 24 can be an 8″×11″ liquid crystal panel LTI Product Number SGULLC.0110, Item number 76869, manufactured by LTI SMART GLASS, Inc., 14 Federico Drive, Pittsfield, Mass. 01201. LTI SMART GLASS panel 24 is composed of a liquid crystal matrix, laminated between transparent coatings and glass. The laminate comprises in the following order: a glass layer, a clear adhesive substrate, an electrified privacy film of liquid crystal particles, a second clear adhesive substrate and a second glass layer. The panel thickness is about 5/16″. The panel operates on 110-120 alternate current volts. Power consumption is approximately 3-5 watts per square meter of glass area. The SMART GLASS panel 24 offers an opaque white privacy while unpowered, and instantly turns transparent when electrified. It is designed to be either ON or OFF at the flip of a switch. When ON the parallel light transmission is 70%/total light: 80% with a haze about 8%. When OFF the parallel light transmission is 5%/total light: 75% with a substantially full haze. The switching speed is approximately one millisecond.

This SMART GLASS panel is available with the glass panes replaced by transparent polycarbonate panes with a total SMART GLASS thickness of one-eighth inch and a fraction of the weight of glass panes, which advantageously substantially reduces the weight load on the VELCRO attachments 25 (FIG. 1). So a SMART GLASS panel with polycarbonate panes is preferable to the glass pane version which is far thicker and heavier.

Also, the LTI panel can be designed as a retrofit panel to be placed inside an existing window opening. So, in an alternative embodiment of the glare reducing invention, SMART GLASS 24 can be retrofitted to the front windshield 20 with the windshield 20 in place of the glass pane adjacent the front windshield 20. For further teaching of retrofitting SMART GLASS see U.S. Pat. No. 6,429,961 B1, Methods for Retrofitting Windows With Switchable and Non-switchable Window Enhancements, issued Aug. 6, 2002 to assignee Research Frontiers Incorporated of Woodbury, N.Y. USA.

As indicated above, in FIG. 3 privacy glass, like SMART GLASS panel 24, has a liquid crystal film 30 laminated between two sheets of glass 32, 34. In am unenergized state, the liquid crystal molecules disperse light, but when energized the liquid crystal molecules are aligned in a manner which permits parallel light to pass through the film. In its unenergized or natural state the liquid crystal film is substantially opaque. It has a milky white appearance and substantially prevents objects from being seen through it. In its transparent state it transmits approximately 70-86 percent of the light in the visible spectrum.

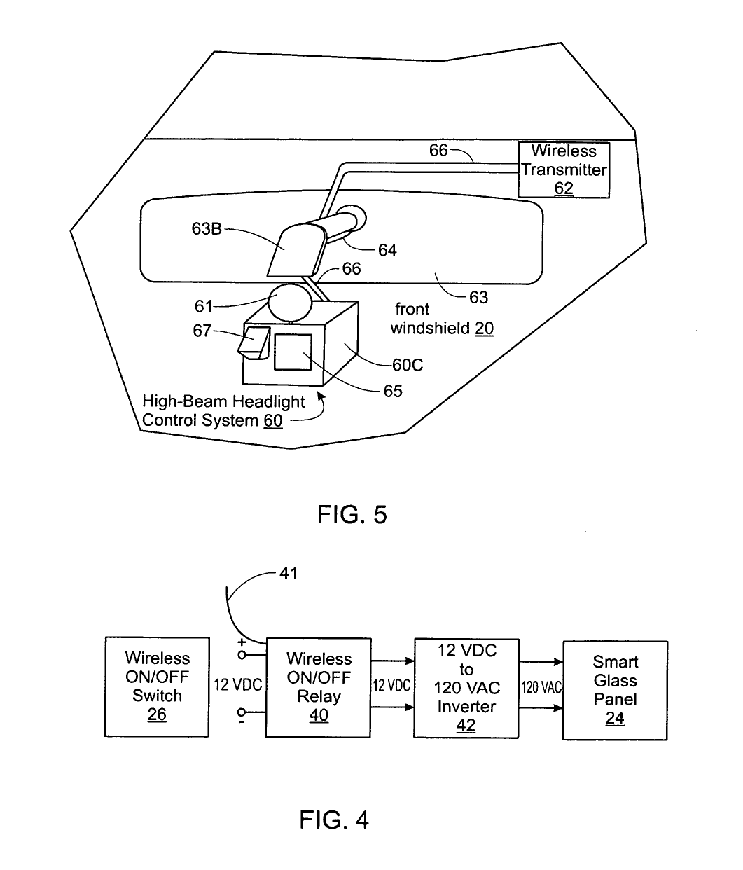

FIG. 4 is a block diagram of the electric circuitry under wireless control of the wireless ON/OFF switch 26 (FIG. 1) comprising a wireless ON-OFF relay 40 (FIG. 4) feeding 12 VDC to a 12 VDC to 120 VAC inverter 42 whose 120 VAC output turns the SMART GLASS panel 24 ON to make the panel substantially clear and when OFF to make the SMART GLASS panel 24 substantially opaque. In the embodiment of the glare reducing attachment as reduced to practice, the 12 VDC input to wireless ON/OFF relay 40 is supplied from a suitable connector plugged into the vehicle's cigarettelighter. Otherwise the 12 VDC directly can be accessed from the vehicle's 12 VDC electric circuitry originating from the vehicle's storage battery. A second input to wireless ON/OFF relay 40 is antenna 41 to receive signals from wireless ON/OFF switch 26.

Wireless ON/OFF relay 40 can be a remote control relay switch to remotely control any 12 VDC device supplied as a Remote Control Molex Connector Kit, Altronix RBR1224 Electronic Ratchet/Toggle Relay Module, by Altronix Corporation, 140 58th Street, Bldg. A, 3 W Brooklyn, N.Y. 11220 USA. The kit includes one 12 VDC remote relay switch receiver and two keys for transmitters. One transmitter is wireless ON/OFF switch 26 (FIG. 1) attached to steering wheel 22. The upper left corner of switch 26 has a red indicator 40I which lights whenever the ON button and the OFF button of switch 26 is depressed. The opening 40A on the right lower corner of switch 26 is an opening for a key ring connector not used in the present invention.

12 VDC to 120 VAC inverter 42 (FIG. 4) can be a 120 watt power inverter supplied as Part # PWRCUP120 by AIMS Power, Inc., 5475 Reno Corporate Drive, Suite 200, Reno, Nev. 89511, USA. This inverter is soda can sized to easily fit into a vehicle's cup holder. It comes with a wire connection to the vehicle's cigarette lighter. It has an on-off switch and a 120 VAC female socket to connect to any 120 VAC device in a vehicle. The on-off switch is left in the on position. This inverter with a 120 watt output capacity is far larger than required to operate the SMART GLASS panel 24 whose power requirement is under five watts. So a smaller inverter is preferable.

The wire connection to the vehicle's cigarette lighter is removed from the input of inverter 42 and connected to the input of wireless ON/OFF relay 40. The 120 VAC wire connected to the SMART GLASS panel 24 has a normal 120 VAC plug which plugs into the 120 VAC female socket of inverter 42. As reduced to practice, wireless ON/OFF relay 40 is taped to 12 VDC to 120 VAC inverter 42 and both are positioned out of the driver's view behind the vehicle's radio panel section.

In this embodiment of the invention the SMART GLASS panel 24 is switched from the substantially clear to the substantially opaque states solely by wireless ON/OFF switch 26.

However, in another glare reducing embodiment of the invention, SMART GLASS panel 24 is automatically operated by a high-beam headlight control system to automatically change SMART GLASS panel 24 to substantially opaque when glare from an oncoming vehicle's headlights is automatically detected and automatically change SMART GLASS 24 panel to substantially transparent when there is no longer headlight glare from an oncoming vehicle. High-beam headlight control system 60 (FIG. 5) is a commercially available system which automatically detects an oncoming vehicle with lit headlights to automatically dim the headlights of the driver's vehicle by turning its headlights to the low beam state. Then headlight control system 60 automatically detects the end of the headlight glare from the oncoming vehicle and automatically returns the headlights of the driver's vehicle to the high-beam state. High-beam headlight control system 60 is attached by a very strong suction cup to the inside of front windshield 20 just below the vehicle's rearview mirror connection to front windshield 20.

In this automatic headlight glare reducing system, high-beam headlight control system 60 (FIG. 5) is modified by adding wireless transmitter 62 to transmit an ON/OFF wireless signal to ON/OFF relay 40 (FIG. 4) to automatically and wirelessly switch SMART GLASS panel 24 between the substantially transparent and substantially opaque positions. Wireless transmitter 62 is fed by cable 66 and is basically the same circuitry and frequency as wireless ON/OFF switch 26 (FIG. 1) except that the electronic result of pressing the OFF button of switch 26 is replaced by a high-beam dimmer signal in the headlight control system 60 and the electronic result of pressing the ON button of switch 26 is replaced by a signal in the headlight control system 60 designed to return the headlights from low beam back to high beam.

So, when high-beam headlight control system 60 (FIG. 5) detects headlight glare from an oncoming vehicle it sends a high-beam dimmer (low beam) signal to wireless transmitter 62 which transmits an OFF signal to wireless ON/OFF relay 40 (FIG. 4) which puts SMART GLASS 24 in the substantially opaque state to substantially reduce the glare. When high-beam headlight control system 60 (FIG. 5) detects the end of headlight glare from an oncoming vehicle it sends a high-beam dimmer off (high beam) signal to wireless transmitter 62 which transmits and ON signal to ON/OFF relay 24 (FIG. 1) to change the state of SMART GLASS 24 to substantially transparent. So when headlight control system 60 (FIG. 5) automatically detects glare from and oncoming vehicle it automatically changes SMART GLASS panel 24 to substantially opaque and when headlight control system 60 automatically detects the end of the glare it automatically changes SMART GLASS panel 24 back to substantially transparent.

However, when the vehicle driver wants to change SMART GLASS panel 24 from substantially opaque to substantially transparent, for example for left turns, the driver only need press the ON button of wireless ON/OFF switch 26 (FIG. 1) to override headlight control system 60 (FIG. 5).

The high-beam headlight control system 60 is shown in FIG. 5 with the view through a vehicle front windshield 20 of the case 60C that encloses the mechanics, optics and associated electronics of headlight control system 60. Case 60C is mounted on the inside surface of front windshield 20 by a strong suction cup 61 just below the rearview mirror's button 63B attached to the inside of the windshield 20 which supports the rearview mirror casing 63. Cable 64 connects the headlight control system 60 to the vehicle's 12 volt direct current supply in the rearview mirror casing 63 directly or by plugging into a light bulb socket in the rearview mirror casing 63 or into a light bulb socket in the vehicle's dome light. Lens 65 is positioned to view the headlights of oncoming vehicles and the tail lamps of leading vehicles and to communicate and focus these signals on a sensor of the control system 60. Lens 67 senses ambient light as described below.

The high-beam headlight control system 60 is disclosed in detail in U.S. Pat. No. 5,537,003 (003 patent) for a Control System for Automotive Vehicle Headlamps and Other Vehicle Equipment issued Jul. 16, 1996 to Gentex Corporation of Zeeland, Mich. In the 003 patent its FIG. 1 corresponds to FIG. 5 in this specification. The 003 description is summarized in its Abstract: “A control system is provided for controlling the energization of the headlamps on a first automotive vehicle, the headlamps being electrically energizable and each having a high beam state and a low beam state. The system includes means for collecting light emanating from a second vehicle and means for collecting ambient light. Sensing means is provided which is effective to selectively sense the intensity of the collected light emanating from the second vehicle and the collected ambient light. In addition, the system includes means controlling the state of the beams of the headlamps as a function of the sensed intensity of the beam of light emanating from said second vehicle, and means controlling the electrical energization of the headlamps as a function of the sensed ambient light.”

The 003 specification also states: “The light guide and entrance lens assembly 3 (67 in FIG. 5) for the headlamp on/off function extends forward from the case 100 (60C in FIG. 5) so that light from a wide area of the sky falls on its entrance lens through the windshield 102 (20 in FIG. 5) and a portion of this light is directed to and sampled by the sensing unit in case 100 (60C in FIG. 5). Likewise the lens 2 (65 in FIG. 5) may be positioned with reasonable but not extraordinary precision to view the headlamps of oncoming vehicles and the tail lamps of leading vehicles and to communicate and focus these signals on the unit's sensor.”

The 003 patent further states: “The cable 105 (66 in FIG. 5) also connects to a relay or relays which energize and de-energize the headlamps, running lamps, and tail lamps and to a relay which switches between the vehicles high beam and low beam configurations.” The latter relay is presumably a commercial auto headlight dim relay. In this specification the 003 patent circuitry is modified so the high beam dimming signal in cable 66 causes wireless transmitter 62 to send an OFF signal to wireless ON/OFF relay 40 and the high beam signal in cable 66 causes wireless transmitter 62 to send an ON signal to wireless ON/OFF relay 40.

The 003 patent also states: “FIG. 7 is a block diagram of the micro controller based control circuit with more detail given for the electronic drive circuit for the motor . . . . The power supply module 700 supplies a 12 V signal to . . . the sensor for its integrated amplifier and to the light sensor interface module . . . . The circuit ground connection GND connects to the automotive ground. The headlamp dimmer and the headlamp on/off control interface includes options to enable or disable the automatic functions . . . . The control interface 702 sends signals . . . to turn the vehicle headlamps, tail lamps, and running lamps on and off as required.” FIG. 7a of the 003 patent discloses a block diagram with a control interface 702 generating a “HIGH BEAM ON/OFF” signal as the input to wireless transmitter 62.

In the high-beam headlight control system 60 of this specification only the circuitry, optics and mechanics of the 003 patent for the headlamp dimmer system and not the headlamp on/off system need be used. However, optionally, the headlamp on/off system and other features of the 003 patent system can be used.

Further alternative embodiments of the invention are useful installed as original equipment in new vehicles.

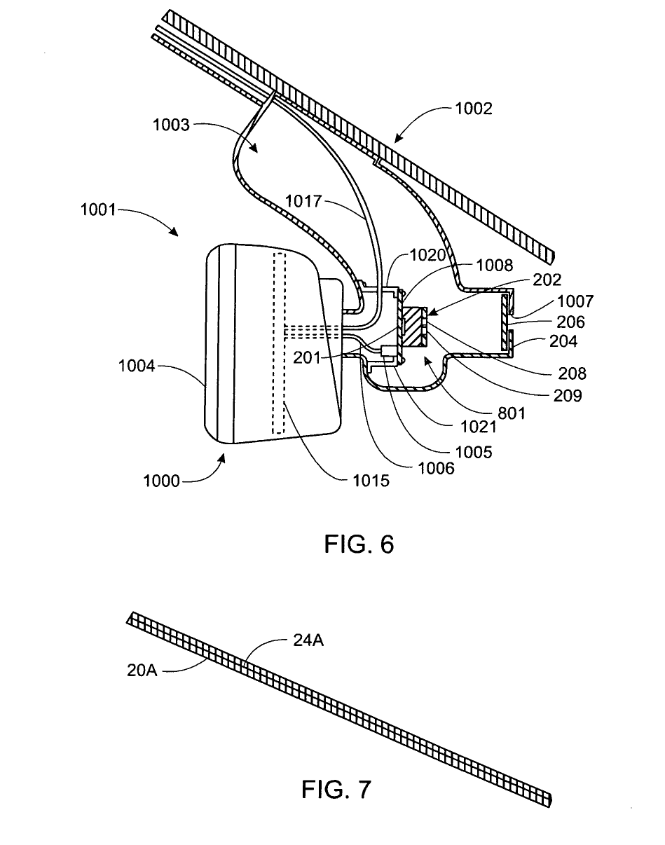

Thus FIG. 6 is a simplified side elevational view of the automatic-high beam headlight control system of FIG. 5 installed as original equipment in a new vehicle. It is disclosed in detail in U.S. Pat. No. 6,947,377 B2 for a Vehicle Lamp Control issued Sep. 20, 2005 to assignee GENTEX Corporation, Zeeland, Mich., USA in which its FIG. 10 corresponds to FIG. 6 of this specification.

As original equipment in a new vehicle FIG. 7 shows a cross-sectional view of the SMART GLASS portion of a new vehicle's front windshield. Front windshield 20A comprises an 8″×11″ laminate 24A of two glass panes separated by a liquid crystal matrix, laminated between transparent coatings as used in SMART GLASS panel 24 described above as LTI Product Number SGULLC.0110, Item number 76869, manufactured by LTI SMART GLASS, Inc. The 8″×11″ portion of front windshield 20A is positioned within windshield 20A as shown as SMART GLASS panel 24 in FIG. 1.

While the invention has been described for use in countries where the convention is to drive on the right side of a road, in those countries with a convention of driving on the left side of the road, as in England, the SMART GLASS panel 24 is positioned on the right side of the windshield above the right side of the steering wheel and operates in a substantially mirror image to that of right side road driving.

Thus, in accordance with the apparatus and method of each of the embodiments of the invention first disclosed in this application, glare reducing systems as attachments, or built into new vehicles as original equipment, have been provided accomplishing all of the objects and having the features and advantages specified in this specification.

What is claimed is:

1. A method of reducing glare from oncoming vehicle headlights, said method comprising:
Providing glare reducing means for a vehicle front windshield, the vehicle having a driver's side and a passenger side, the glare reducing means adapted to substantially transmit light and to substantially block light, the glare reducing means having a width less than 30 percent of the horizontal width of the vehicle's front windshield and the passenger side being unblocked;
Providing automatic optical detecting means on the vehicle for automatically optically detecting when an oncoming vehicle with lit headlights is approaching the driver and automatically optically detecting when an oncoming vehicle with lit headlights is not approaching the driver;
Driving the vehicle on a surface that can have oncoming traffic;
Automatically optically detecting when at least one oncoming vehicle with lit headlights is approaching the driver;
Automatically operating the glare reducing means to substantially block transmitted light in response to automatically optically detecting when at least one oncoming vehicle with lit headlights is approaching the driver to reduce headlight glare through the glare reducing means when there is at least one oncoming vehicle with lit headlights approaching;
Automatically optically detecting when an oncoming vehicle with lit headlights is not approaching the driver;
Automatically operating the glare reducing means to substantially transmit light in response to automatically optically detecting when an oncoming vehicle with lit headlights is not approaching the driver to allow a driver to see through the glare reducing means when there is no oncoming traffic with lit headlights approaching; and
Repeating the automatic substantially light blocking and automatic substantially light transmitting steps by the glare reducing means while driving to accommodate varying oncoming traffic.

2. A method of reducing glare from oncoming vehicle headlights according to claim 1 wherein the glare reducing means is a SMARTGLASS panel attached to the vehicle's front windshield.

3. A method of reducing glare from oncoming vehicle headlights according to claim 1 wherein the glare reducing means is SMARTGLASS comprising the vehicle's front windshield.

4. A glare reducing system for a vehicle having a driver's side and a passenger's side comprising:
(A) a front windshield on said vehicle;
(B) glare reducing means on said vehicle adapted to substantially transmit light and to substantially block light through said front windshield, said glare reducing means having a width less than 30 percent of the horizontal width of said front windshield and said passenger's side being unblocked;
(C) automatic optical detecting means on said vehicle for automatically detecting when there is an oncoming vehicle with lit headlights and when there is no oncoming vehicle with lit headlights;
(D) whereby for nighttime driving said automatic optical detecting means operates said glare reducing means to substantially transmit light when there is no oncoming vehicle with lit headlights to allow a driver to see through said glare reducing means; and
(E) whereby for nighttime driving said automatic detecting means operates said glare reducing means to substantially reduce light when there is an oncoming vehicle with lit headlights to reduce glare.

5. A glare reducing system for a vehicle according to claim 4 wherein said glare reducing means is a SMARTGLASS panel attached to said vehicle's front windshield.

6. A glare reducing system for a vehicle according to claim 4 wherein said glare reducing means is SMARTGLASS comprising the vehicle's front windshield.

7. A glare reducing system for a vehicle having a driver's side and a passenger's side comprising:
(A) a front windshield on the vehicle;
(B) glare reducing means on the vehicle adapted to substantially transmit light and to substantially block light, said glare reducing means having a width less than 30 percent of the horizontal width of said front windshield and the passenger's side being unblocked;
(C) whereby for nighttime driving said glare reducing means operates to substantially transmit light when there is no oncoming vehicle with lit headlights to allow a driver to see through said glare reducing means and to substantially reduce transmitted light when there is an oncoming vehicle with lit headlights to reduce glare.

8. A glare reducing system according to claim 7 further comprising:
(D) a manually operated switch on the vehicle adapted to operate said glare reducing means to substantially transmit light and to substantially block light.

9. A method of reducing glare from oncoming vehicle headlights, said method comprising:
Providing an attachment for a vehicle, said vehicle having a driver's side, a passenger side, a front windshield and a steering wheel, said attachment comprising:
Glare reducing means adapted to substantially transmit light and to substantially reduce light, said glare reducing means having a width less than 30 percent of the horizontal width of the vehicle's front windshield;
Securing said glare reducing means with mounting means in front of the vehicle's front windshield on the driver's side such that the passenger side is uncovered;
Driving said vehicle on a surface that can have oncoming traffic;
Operating said glare reducing means while driving to substantially transmit light to allow a driver to see through said glare reducing means when there is no oncoming traffic with lit headlights approaching;
Operating said glare reducing means to substantially reduce light while driving to reduce glare when there is at least one oncoming vehicle with lit headlights approaching the driver; and
Repeating the substantially light transmitting and substantially light reducing steps by said glare reducing means while driving to accommodate varying oncoming traffic.

10. A method of reducing glare from oncoming vehicle headlights according to claim 9 wherein said glare reducing means comprises a SMARTGLASS panel operated by a wireless switch.

11. A method of reducing glare from oncoming vehicle headlights according to claim 10 wherein said wireless switch is attached to the vehicle's steering wheel.

12. A glare reducing system for a vehicle according to claim 7 wherein said glare reducing means is a SMARTGLASS panel attached to the inside of said vehicle's front windshield.

13. A glare reducing system for a vehicle according to claim 7 wherein a portion of said vehicle's front windshield comprises SMARTGLASS.

14. A glare reducing system for a vehicle according to claim 7 further comprising automatic optical detecting means on said vehicle to operate said glare reducing means to substantially transmit light when there is no oncoming vehicle with lit headlights to allow a driver to see through said glare reducing means and to substantially reduce transmitted light when there is an oncoming vehicle with lit headlights to reduce glare.

15. A glare reducing system for a vehicle according to claim 14 further comprising a wireless switch to manually operate said glare reducing means to substantially transmit light when there is no oncoming vehicle with lit headlights to allow a driver to see through said glare reducing means and to substantially reduce transmitted light when there is an oncoming vehicle with lit headlights to reduce glare.

16. A glare reducing system for a vehicle according to claim 14 further comprising a rearview mirror comprising automatic optical detecting means attached to the inside of the vehicle's front windshield, said automatic optical detecting automatically optically detecting when there is an oncoming vehicle with lit headlights and when there is no oncoming vehicle with lit headlights;
whereby for nighttime driving said automatic optical detecting means operates said glare reducing means to substantially transmit light when there is no oncoming vehicle with lit headlights to allow a driver to see through said glare reducing means; and
whereby for nighttime driving said automatic detecting means operates said glare reducing means to substantially reduce light when there is an oncoming vehicle with lit headlights to reduce glare.

17. A glare reducing system for a vehicle according to claim 16 wherein said automatic optical detecting means operates said glare reducing means by a wireless transmitter.

18. A glare reducing system for a vehicle according to claim 16 wherein said glare reducing means is a SMARTGLASS panel attached to the inside of said vehicle's front windshield.

19. A glare reducing system for a vehicle according to claim 16 wherein a portion of said vehicle's front windshield comprises said glare reducing means comprising SMARTGLASS.

20. A glare reducing system for a vehicle according to claim 4 further comprising a switch to manually operate said glare reducing means to substantially transmit light to allow a driver to see through said glare reducing means if there is an oncoming vehicle with glaring headlights or when the vehicle is making a left turn.
